(19) United States
(12) Patent Application Publication
(10) Pub. No.: US 2007/0090310 A1
(43) Pub. Date: Apr. 26, 2007

(54) Methods and apparatus for inspecting an object

(75) Inventors: Donald Wagner Hamilton, Burnt Hills, NY (US); Qingying Hu, Clifton Park, NY (US); Kevin George Harding, Niskayuna, NY (US); Joseph Benjamin Ross, Cincinnat, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/259,343

(22) Filed: Oct. 24, 2005

(51) Int. Cl. G01N 21/88; G01B 11/30

(52) U.S. Cl. 250/559.45; 356/603

(57) ABSTRACT

A method for inspecting an object using a structured light measurement system that includes a light source and an imaging sensor includes illuminating each of a plurality of different areas of the object with different wavelengths of light using the light source, filtering light reflected from the object into a first wavelength of the different wavelengths, and receiving the first wavelength of light reflected from the object with the imaging sensor.

### BACKGROUND OF THE INVENTION

This application relates generally to inspecting objects, and more specifically to methods and apparatus for inspecting objects using a light measurement system.

Objects are sometimes inspected, for example, to determine a size and/or shape of all or a portion of the object and/or to detect defects in the object. For example, some gas turbine engine components, such as turbine or compressor blades, are inspected to detect fatigue cracks that may be caused by vibratory, mechanical, and/or thermal stresses induced to the engine. Moreover, and for example, some gas turbine engine blades are inspected for deformations such as platform orientation, contour cross-section, bow and twist along a stacking axis, thickness, and/or chord length at given cross-sections. Over time, continued operation of the object with one or more defects may reduce performance of the object and/or lead to object failures, for example, as cracks propagate through the object. Accordingly, detecting defects of the object as early as possible may facilitate increasing the performance of the object and/or reducing object failures.

To facilitate inspecting objects, at least some objects are inspected using a light measurement system that projects a structured light pattern onto a surface of the object. The light measurement system images the structured light pattern reflected from the surface of the object and then analyzes the deformation of the reflected light pattern to calculate the surface features of the object. More specifically, during operation, the object to be inspected is typically coupled to a test fixture and positioned proximate to the light measurement system. A light source is then activated such that emitted light illuminates the object to be inspected. However, a resultant image of the object may include noise caused by multiple bounce reflections of the emitted light. Such noise may result in reduced image quality and poor measurement results, possibly leading to an incorrect interpretation of surface features of the object. For example, light reflected off of prismatic surfaces of the object may cause multiple bounce reflections. Moreover, and for example, multiple bounce reflections may be caused by inter-reflections between the object and portions of the test fixture illuminated by the light source. For example, multiple bounce reflections may be caused if the test fixture has a shape or finish that casts reflections on the object, and/or if the object has a relatively mirror-like finish that reflects an image of the test fixture.

Some light measurement systems use a pair of crossed polarized filters to reduce, eliminate, and/or identify noise caused by multiple bounce reflections. However, different areas of the object may produce multiple bounce reflections having different polarizations. Accordingly, it may sometimes not be possible to completely eliminate multiple bounce reflections when illuminating different areas of the object. Moreover, the polarization of multiple bounce reflections may depend upon a material and/or orientation of the object, and the polarized filters may therefore need to be changed and/or adjusted when the object is moved or an object having a different shape and/or material is inspected. Furthermore, because the refractive index of some metals may be complex, it may be difficult and/or time-consuming to determine an optimal polarization angle of the filters when an illuminate surface of the object includes metal.

### BRIEF DESCRIPTION OF THE INVENTION

In one aspect, a method is provided for inspecting an object using a structured light measurement system that includes a light source and an imaging sensor. The method includes illuminating each of a plurality of different areas of the object with different wavelengths of light using the light source, filtering light reflected from the object into a first wavelength of the different wavelengths, and receiving the first wavelength of light reflected from the object with the imaging sensor.

In another aspect, a method is provided for inspecting an object using a light measurement system that includes a light source, a first imaging sensor, and a second imaging sensor. The method includes illuminating a first area of the object with a first wavelength of light using the light source, illuminating a second area of the object with a second wavelength of light using the light source, filtering light reflected from the object into the first wavelength, receiving the first wavelength of light reflected from the object with the first imaging sensor, filtering light reflected from the object into the second wavelength, and receiving the second wavelength of light reflected from the object with the second imaging sensor.

In another aspect, a structured light measurement system for inspecting an object includes a structured light source configured to project a first wavelength of structured light onto a first area of the object and a second wavelength of structured light onto a second area of the object;, a first color filter configured to filter light reflected from the object into the first wavelength of light, a first imaging sensor configured to receive the first wavelength of light filtered by the first color filter, a second color filter configured to filter light reflected from the object into the second wavelength of light, and a second imaging sensor configured to receive the second wavelength of light filtered by the second color filter.

### BRIEF DESCRIPTION OF THE DRAWINGS

FIG. 1 is a block diagram of an exemplary embodiment of a structured light measurement system.

FIG. 2 is a side sectional view of an object under inspection, illustrating single and multiple bounce light paths.

FIG. 3 is a block diagram of another exemplary embodiment of a structured light measurement system.

FIG. 4 is a flow chart illustrating an exemplary method for inspecting an object using the structured light measurement system shown in FIGS.

### DETAILED DESCRIPTION OF THE INVENTION

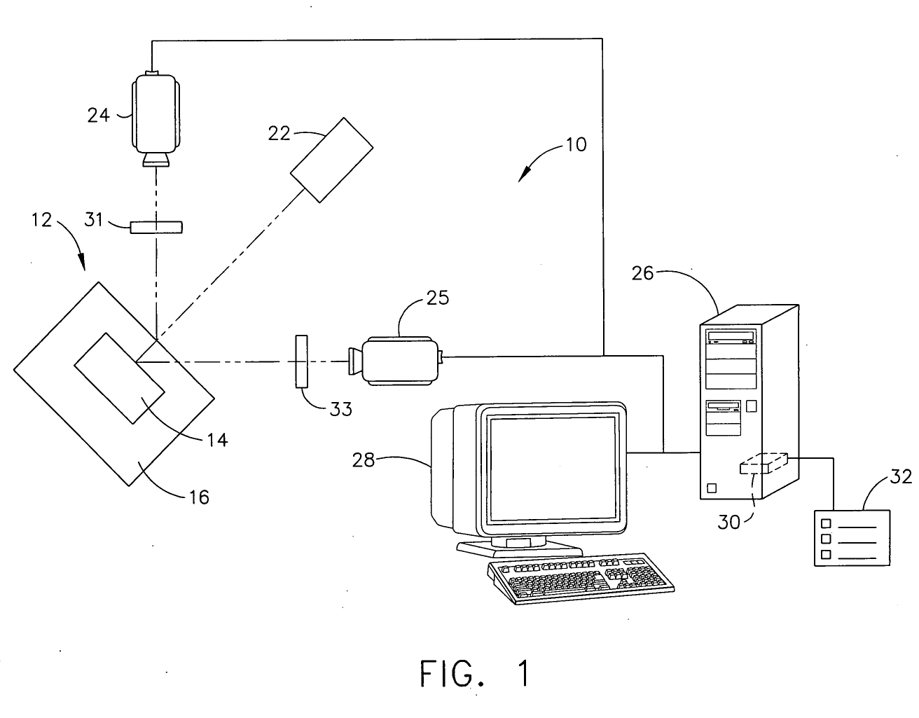

FIG. 1 is a block diagram of an exemplary embodiment of a structured light measurement system 10 that is used to measure a plurality of surface features of an object 12. For example, system 10 may be used to inspect and determine surfaces of object 12, wherein the surfaces may include features such as tilts, bends, twists, and/or warps when compared to a model representative of object 12.

In the exemplary embodiment, object 12 is a rotor blade, such as, but not limited to, a compressor or a turbine blade utilized in a turbine engine. Accordingly, and in the exemplary embodiment, object 12 includes an airfoil 14 extending outwardly from a platform 16. While the following description is directed to inspecting gas turbine engine blades, one skilled in the art will appreciate that inspection system 10 may be utilized to improve structured light imaging for any object.

System 10 also includes one or more structured light sources 22, such as, but not limited to, a laser, a white light lamp, a liquid crystal display (LCD) device, a liquid crystal on silicon (LCOS) device, and/or a digital micromirror device (DMD). System 10 also includes two or more imaging sensors 24 and 25 that receive structured light reflected from object 12. In the exemplary embodiment, imaging sensor(s) 24 and 25 are cameras that receive and create images using structured light reflected from object 12, although other imaging sensors 24 and 25 may be used. One or more computers 26 process images received from sensors 24 and/or 25, and a monitor 28 may be utilized to display information to an operator. In one embodiment, computer(s) 26 include a device 30, for example, a floppy disk drive, CD-ROM drive, DVD drive, magnetic optical disk (MOD) device, and/or any other digital device including a network connecting device such as an Ethernet device for reading instructions and/or data from a computer-readable medium 32, such as a floppy disk, a CD-ROM, a DVD, and/or another digital source such as a network or the Internet, as well as yet to be developed digital means. In another embodiment, computer(s) 26 execute instructions stored in firmware (not shown). Computer(s) 26 are programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

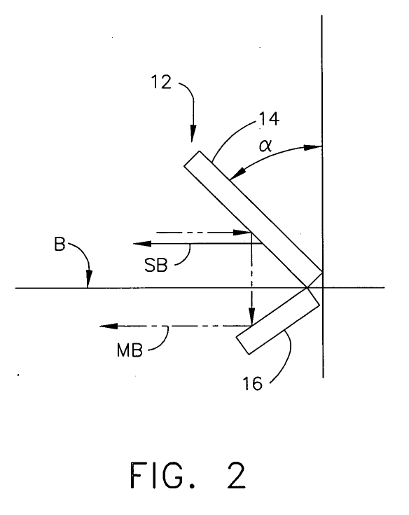

FIG. 2 is a side sectional view of object 12. During operation, an object to be inspected, for example object 12, is coupled to a test fixture (not shown) and positioned proximate to system 10. In some embodiments, object 12 is orientated relative to light source(s) 22 (shown in FIG. 1) with an angle \acute{α} of orientation that enables a view to be presented to imaging sensors 24 (shown in FIG. 1) such that a plane β defined by light source(s) 22 and imaging sensors 24 and/or 25 substantially bisects one or more prismatic features of object 12. For example, in the exemplary embodiment, airfoil 14 and platform 16 each define a prismatic feature of object 12.

Light source(s) 22 are then activated causing emitted light to illuminate object 12. Imaging sensors 24 and/or 25 obtain an image of the emitted light pattern projected onto object 12. However, a resultant image of object 12 may include noise caused by multiple bounce reflections of the emitted light. Such noise may result in a reduced image quality and poor measurement results, possibly leading to an incorrect interpretation of surface features of object 12. For example, light reflected off of prismatic surfaces (e.g., intersecting surfaces of airfoil 14 and platform 16) of object 12 may cause multiple bounce reflections, as illustrated in FIG. 2. Directly reflected light paths, sometimes referred to as single bounce reflections, are indicated as SB in FIG. 2, and multiple bounce reflections are indicated as MB in FIG. 2. Moreover, and for example, multiple bounce reflections MB may be caused by inter-reflections between object 12 and portions of the test fixture illuminated by light source 22. For example, multiple bounce reflections MB may be created if the test fixture has a shape or finish that casts reflections on object 12, and/or if object 12 has a relatively mirror-like finish that reflects an image of the test fixture.

To facilitate reducing or eliminating multiple bounce reflections MB, light source(s) 22 illuminate at least two different areas of object 12 with different wavelengths, or colors, of light. Each of imaging sensors 24 and 25 receives a different wavelength of light to facilitate inspecting a corresponding area of object 12 without noise from multiple bounce reflections MB from other areas of object 12. For example, in one exemplary embodiment, light source(s) 22 project a first wavelength of light, for example blue, onto a first area of object 12, for example platform 16, and a second wavelength of light, for example red, onto a second area of object 12, for example, airfoil 14. Although only two areas of object 12 are illuminated by different wavelengths of light, any number of different areas of object 12 may be illuminated with any number of different wavelengths of light. Moreover, the different areas may overlap in some embodiments. Furthermore, although only one light source 22 is illustrated, any number of light sources 22, whether at generally the same or different position, such as, but not limited to, distance and/or angle of view, with respect to object 12, may be used to illuminate any number of different areas of object 12 with any number of wavelengths of light.

System 10 includes two or more color filters 31 and 33 for filtering light reflected from object 12 into different wavelengths that correspond to the wavelengths projected onto the different areas of object 12. The light filtered by color filters 31 and 33 is then received by a respective imaging sensor 24 and 25. For example, in the exemplary embodiment, color filter 31 filters light reflected from object 12 into blue light for reception by imaging sensor 24 and color filter 33 filters light reflected from object 12 into red light for reception by imaging sensor 25. Accordingly, imaging sensor 24 receives blue light reflected from object 12 and thereby receives light reflected from platform 16 of object 12 for inspection thereof. However, because color filter 31 filters out wavelengths of light other than blue, color filter 31 facilitates reducing or eliminating multiple bounce reflections MB caused by, for example red light originally reflected from airfoil 14. Similarly, imaging sensor 25 receives red light reflected from object 12 and thereby receives light reflected from airfoil 14 of object 12 for inspection thereof. However, because color filter 33 filters out wavelengths of light other than red, color filter 33 facilitates reducing or eliminating multiple bounce reflections MB caused by, for example blue light originally reflected from platform 16. Although imaging sensors 24 and 25 are illustrated as positioned differently with respect to object 12, and more specifically are illustrated at different angles of view with respect to object 12, imaging sensors 24 and 25 may be positioned generally the same with respect to object 12, such as, but not limited to, distance and/or angle of view.

The light received by imaging sensors 24 and 25 can then be analyzed to determine, for example, features of object 12 such as, but not limited to, surface texture, surface orientation, and/or a material used in fabricating object 12. In some embodiments, the images, or data, representing the light received by two or more of imaging sensors 24 and 25 is merged to create a common image of light reflected from object 12.

Color filters 31 and 33 may be configured to filter light reflected from object 12 into any wavelength of light. In some embodiments, and as shown in FIG. 1, color filters 31 and 33 are positioned at least partially between respective imaging sensors 24 and 25 and object 12 for filtering light reflected from object 12 before being received by imaging sensors 24 and 25, respectively. Although two color filters 31 and 33 are illustrated in FIG. 1, system 10 may include any number of color filters 31 and 33 used to filter any number of different wavelengths of light. Although other color filters 30 and/or 32 may be used, in some embodiments color filters 30 and/or 32 include a dichroic mirror.

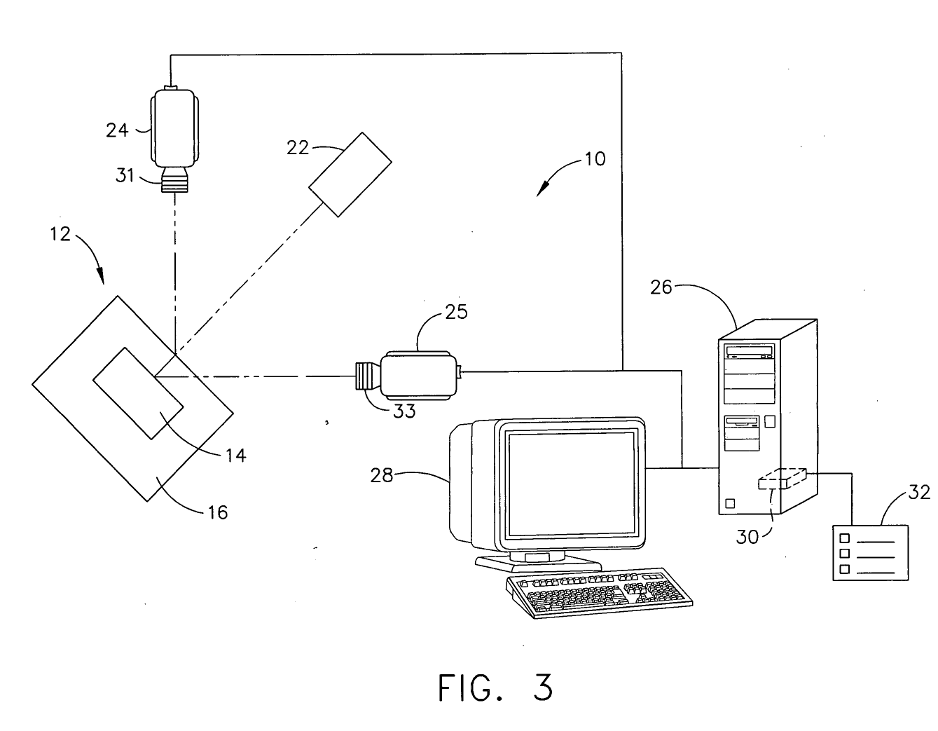

FIG. 3 is a block diagram of another exemplary embodiment of structured light measurement system 10 wherein imaging sensors 24 and 25 include color filters 31 and 33, respectively. For example, in some embodiments color filters 30 and/or 32 are electronic filters associated with a computer, such as, but not limited to computer(s) 26. In other embodiments, color filters 30 and/or 32 are physical filters contained within imaging sensors 24 and/or 25, respectively. Of course, other configurations and/or arrangements of lights source(s) 22, color filters 31 and 33, imaging sensors 24 and 25, and/or other components of system 10 may be used without departing from the scope of system 10, whether described and/or illustrated herein.

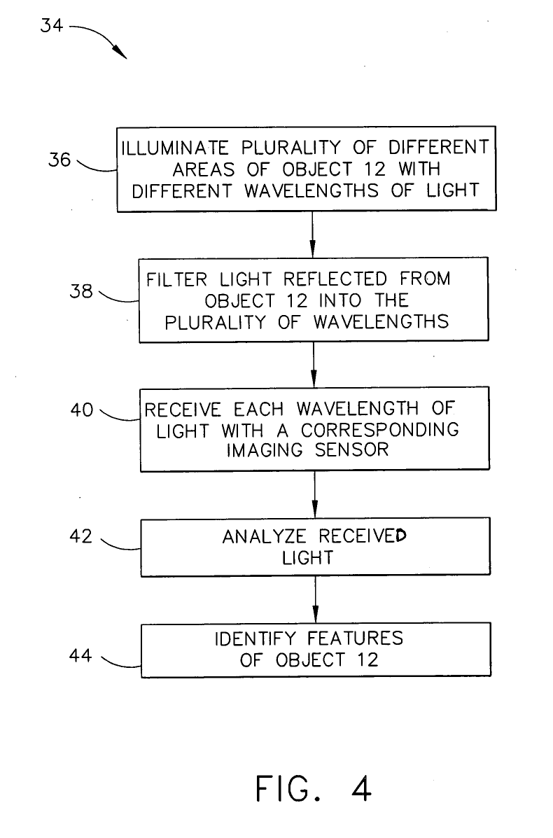

FIG. 4 is a flow chart illustrating an exemplary embodiment of a method 34 for inspecting object 12 (shown in FIGS. 1-3) using structured light measurement system 10 (shown in FIGS. 1 and 3). Method 34 includes illuminating 36 each of a plurality of different areas of object 12 with different wavelengths of light using light source(s) 22, and filtering 38 light reflected from the object into the plurality of different wavelengths using color filters 31 and 33. Each wavelength of filtered light is then received 40 by a corresponding imaging sensors 24 and 25 and analyzed 42 to identify 44 features of object 12, such as, but not limited to, surface texture, surface orientation, and a material used in fabricating object 12.

For example, features of object 12, such as, but not limited to, surface texture, surface orientation, and a material used in fabricating object 12 can be readily identified from the image created by light reflected from the object using conventional image processing techniques, such as, but not limited to, ellipsometric analysis, triangulation techniques, and/or phase-shifting techniques. Moreover, The image created by light reflected from object 12 may be analyzed 46 to segment 50 a portion of object 12, for example, based on at least one of surface texture, surface orientation, and a material used in fabricating the portion of the object. For example, specific regions in an image known to contain erroneous or irrelevant information may be digitally masked or blocked from further processing. Similarly, using known information, an image of object 12 undergoing measurement may be correlated or registered to a stored reference image, facilitating identification of differences between object 12 and an ideal model or representation of object 12.

The above-described structured light measurement system 10 may facilitate inspecting object 12 more quickly and efficiently. More specifically, by illuminating different areas of object 12 with different wavelengths of light and receiving each different wavelength of light reflected from object 12 with a different imaging sensor, multiple bounce reflections MB can be reduced or eliminated. Accordingly, system 10 may facilitate reducing noise in a resultant image of object 12, possibly thereby facilitating improving image quality and measurement results. Moreover, because system 10 does not rely on polarization to reduce or eliminate multiple bounce reflections MB, system 10 may not need to be changed and/or adjusted when object 12 is moved or another object having a different shape and/or material is inspected.

Although the systems and methods described and/or illustrated herein are described and/or illustrated with respect to gas turbine engine components, and more specifically an engine blade for a gas turbine engine, practice of the systems and methods described and/or illustrated herein is not limited to gas turbine engine blades, nor gas turbine engine components generally. Rather, the systems and methods described and/or illustrated herein are applicable to any object.

Exemplary embodiments of systems and methods are described and/or illustrated herein in detail. The systems and methods are not limited to the specific embodiments described herein, but rather, components of each system, as well as steps of each method, may be utilized independently and separately from other components and steps described herein. Each component, and each method step, can also be used in combination with other components and/or method steps.

When introducing elements/components/etc. of the assemblies and methods described and/or illustrated herein, the articles “a”, “an”, “the” and “said” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A method for inspecting an object using a structured light measurement system that includes a light source and an imaging sensor, said method comprising:
illuminating each of a plurality of different areas of the object with different wavelengths of light using the light source;
filtering light reflected from the object into a first wavelength of the different wavelengths; and
receiving the first wavelength of light reflected from the object with the imaging sensor.

2. A method in accordance with claim 1 wherein receiving the first wavelength of light comprises receiving the first wavelength of light with a first imaging sensor, said method further comprising:
filtering light reflected from the object into a second wavelength of the different wavelengths;
receiving the second wavelength of light reflected from the object with a second imaging sensor; and
merging images of the first and second wavelengths from the first and second imaging sensors into a common image.

3. A method in accordance with claim 1 wherein illuminating each of a plurality of different areas of the object comprises illuminating each of the plurality of different areas of the object with a plurality of light sources.

4. A method in accordance with claim 1 wherein filtering light reflected from the object in to a first wavelength comprises filtering out multiple bounce reflections.

5. A method in accordance with claim 1 further comprising analyzing the first wavelength of light received by the imaging sensor to facilitate inspecting at least a portion of the object.

6. A method in accordance with claim 5 wherein analyzing the first wavelength of light received by the image sensor comprises identifying at least one of a surface texture, a surface orientation, and a material used in fabricating the object.

7. A method in accordance with claim 6 further comprising segmenting a portion of the object based on at least one of the surface texture, the surface orientation, and the material of the object.

8. A method in accordance with claim 1 wherein illuminating each of a plurality of different areas of the object with different wavelengths of light comprises illuminating the object using at least one of a liquid crystal display (LCD) device, a liquid crystal on silicon (LCOS) device, and a digital micromirror device (DMD).

9. A method for inspecting an object using a light measurement system that includes a light source, a first imaging sensor, and a second imaging sensor, said method comprising:
illuminating a first area of the object with a first wavelength of light using the light source;
illuminating a second area of the object with a second wavelength of light using the light source;
filtering light reflected from the object into the first wavelength;
receiving the first wavelength of light reflected from the object with the first imaging sensor;
filtering light reflected from the object into the second wavelength; and
receiving the second wavelength of light reflected from the object with the second imaging sensor.

10. A method in accordance with claim 9 wherein:
illuminating a first area of the object with a first wavelength of light using the light source comprises illuminating the first area with a first light source; and
illuminating a second area of the object with a second wavelength of light using the light source comprises illuminating the second area with a second light source.

11. A method in accordance with claim 9 wherein:
filtering light reflected from the object into the first wavelength comprises filtering out multiple bounce reflections; and
filtering light reflected from the object into the second wavelength comprises filtering out multiple bounce reflections.

12. A method in accordance with claim 9 further comprising:
merging data of the first wavelength of light received by the first imaging sensor with data of the second wavelength of light received by the second imaging sensor to create an image; and
analyzing the image to facilitate inspecting at least a portion of the object.

13. A method in accordance with claim 12 wherein analyzing the image comprises identifying at least one of a surface texture, a surface orientation, and a material used in fabricating the object.

14. A method in accordance with claim 13 further comprising segmenting a portion of the object based on at least one of the surface texture, the surface orientation, and the material of the object.

15. A structured light measurement system for inspecting an object, said structured light measurement system comprising:
a structured light source configured to project a first wavelength of structured light onto a first area of the object and a second wavelength of structured light onto a second area of the object;
a first color filter configured to filter light reflected from the object into the first wavelength of light;
a first imaging sensor configured to receive the first wavelength of light filtered by said first color filter;
a second color filter configured to filter light reflected from the object into the second wavelength of light; and
a second imaging sensor configured to receive the second wavelength of light filtered by said second color filter.

16. A system in accordance with claim 15 wherein said first imaging sensor comprises said first color filter and said second imaging sensor comprises said second color filter.

17. A system in accordance with claim 15 wherein said first color filter is positioned at least partially between the object and said first imaging sensor and said second color filter is positioned at least partially between the object and said second imaging sensor.

18. A system in accordance with 15 wherein said first and second color filters comprise dichroic mirrors.

19. A system in accordance with claim 15 wherein said structured light source comprises a first light source configured to project the first wavelength of structured light onto the first area of the object and a second light source configured to project the second wavelength of structured light onto the second area of the object.

20. A system in accordance with claim 15 wherein said light source comprises at least one of an LCD device, a LCOS device, and a DMD.
